(19) United States
(12) Patent Application Publication
(10) Pub. No.: US 2012/0128133 A1
(43) Pub. Date: May 24, 2012

(54) CONVEYOR CHAIN FOR A RADIOGRAPHIC INSPECTION SYSTEM AND RADIOGRAPHIC INSPECTION SYSTEM

(75) Inventor: Nigel John King, Langford Bedfordshire (GB)

(73) Assignee: METTLER-TOLEDO SAFELINE X-RAY LTD., Royston Hertfordshire (GB)

(21) Appl. No.: 13/301,561

(22) Filed: Nov. 21, 2011

Related U.S. Application Data
(63) Continuation of application No. PCT/EP2010/057351, filed on May 27, 2010.

(30) Foreign Application Priority Data
May 29, 2009 (EP) 09007252.1

(51) Int. Cl. B65G 17/40; H05G 1/00

(52) U.S. Cl. 378/208; 198/850

(57) ABSTRACT

A conveyor chain comprising rigid segments which extend over a width of the chain and are configured at least in part as plates of a uniform thickness and density. The segments are connected together in a loop and have elements to couple each segment to a following segment and a preceding segment. Neighboring segments may flex against each other from a substantially straight line to a convex angle in relation to the loop, so that the chain is adapted to conform to rollers or sprockets, but is resistant to flexing in the opposite direction. The segments overlap each other to form a transport area of substantially uniform thickness and density to provide at least one substantially gapless band of substantially uniform transmissivity to radiation in the transport area, wherein the connector elements are located outside the transport area. A system comprising the chain is also provided.

This application is a continuation of International Patent Application No. PCT/EP2010/057351, filed May 27, 2010, which claims priority to European Patent Application No. 09007252.1, filed May 29, 2009, each of which is hereby incorporated by reference in its entirety.

### BACKGROUND AND SUMMARY OF THE INVENTION

Exemplary embodiments of the invention relate generally to a conveyor belt, more specifically a conveyor chain that is comprised of a multitude of rigid segments or links that are connected to each other in a closed loop, wherein each link is articulately hinged to a following link and a preceding link. Exemplary embodiments of the invention further relate to a radiographic inspection system that includes the conveyor chain as a component.

One exemplary embodiment of an endless conveyor chain may be used in an inspection system in which the objects under inspection are transported by a conveyor belt or conveyor chain through an X-ray machine or other radiographic scanner system, e.g., for the detection of foreign bodies in bottled or canned food and beverage products. Of particular concern is the detection of metal and glass fragments in liquid products. Due to their higher density relative to the liquid, such foreign bodies will often collect at the bottom of the container. Furthermore, if the container has a domed bottom, the foreign bodies will tend to settle at the perimeter where the bottom meets the sidewall of the container. With respect to this example, it may therefore be very important for the radiographic scanner system to be configured and arranged in relation to the conveyor chain in such a way that the entire inside bottom surface of each container is substantially covered by the scan. Consequently, it may be necessary to use a scanner arrangement where at least part of the radiation passes through the bottom of the container and therefore also through the area of the conveyor belt or conveyor chain on which the container is standing. The rays used for the inspection may, for example, originate from a source located above the belt or chain, pass at an oblique angle through the sidewall into the container, exit through the container bottom and pass through the belt, to be received by a camera system, which is connected to an image-processing system. If the radiographic inspection system is an X-ray system, the rays may be received, for example, by an x-ray image intensifier and a camera, or by an X-ray line array sensor, both of which may then pass a signal to the image processing system.

A known inspection system of the generic type is described in U.S. Pat. No. 7,106,827 B2. According to this reference, the transport device for the containers can be a customary link-chain conveyor with plastic chain links or, if the chain links interfere with the X-ray image, a belt conveyor can be used in which the containers are transported by means of two laterally engaging belts.

To the extent that conveyor belts are used as transport devices in radiographic inspection systems, they are in most cases fabric polymer belts. This type of conveyor has the feature that the quality of the X-ray image is least affected by it, due to the constant thickness and the uniformity of the belt. However, there is strong resistance to the use of fabric belts in the bottling and canning industry, because they are easily damaged and wear out rapidly. In comparison, conveyor chains consisting of rigid plastic elements (typically of acetal resin or polypropylene) that are linked together in an endless loop are much stronger and less easily damaged by hard metal or glass containers. Conveyor chains are also easier to replace or repair than belts, because the chain can be opened by removing the hinge pins by which the modular elements of the chain are linked together. Finally, conveyor chains can be designed to be self-tracking and to run flush with the side of the conveyor structure. This last characteristic is important, because it allows products to be easily transferred sideways between laterally adjacent conveyors.

On the other hand, as mentioned in U.S. Pat. No. 7,106,827 B2, the use of customary chain conveyors with plastic chain links is problematic in radiographic inspection systems, because the chain links can interfere with the X-ray image. For example, in a known conveyor chain with plastic chain links as described in EP 0 990 602 A1, the transport surface of each link has a metallic coating or sheet metal overlay as protection against abrasive wear, and the hinge pins are made of metal. In another known conveyor chain which is described in EP 0 597 455 A1, the transport surface has plastic plate elements that are fastened to metallic link elements which form the actual chain. In the foregoing examples of the existing known art, the metallic parts alone would make these conveyor chains unsuitable for a radiographic inspection system. In addition, the structured surface topography of the underside of the plastic conveyor chain segments as well as the open gaps in the transition areas between neighboring segments, which are evident from the drawings in the cited references, run counter to the requirement of a homogeneous transport surface of uniform thickness and density, and thus uniform transmissivity to radiation, which is necessary to produce an optimal radiographic image.

U.S. Pat. No. 5,040,670 discloses a tortilla making machine conveyor including an endless band that is composed of elongated narrow boards connected to each other by hinges installed on outside boarder areas of the boards. These boards being of rectangular cross section provide an essentially flat exterior surface adapted to support tortillas.

U.S. Pat. No. 1,136,578 shows a conveyor that is composed of links hinged to each other. A conveyor floor is achieved by mounting a strip in a central portion thereof to a plate-like portion provided on each of the links. The strips form a flat surface and comprise down-turned flanges with beveled corners in the direction of movement, the function of which is to stabilize the strips.

In light of the shortcomings of the known art, an exemplary embodiment of a conveyor for a radiographic inspection system may combine the advantages of uniform thickness and density of a fabric-backed polymer belt with the stability and wear-resistance of a chain of articulately connected rigid elements. An exemplary embodiment may also provide a radiographic inspection system that includes this example of a conveyor as a component.

An exemplary embodiment of a conveyor chain may be comprised of a multitude of rigid segments which extend over the entire width of the conveyor chain and which in the lengthwise direction of the chain are connected together in a closed loop. Each segment may be articulately coupled by connector elements to a next-following segment and a preceding segment in such a way that neighboring segments may flex against each other from a substantially straight line to a convex angle in relation to the chain loop, so that the conveyor chain is able to conform to conveyor rollers but is essentially resistant to flexing in the opposite direction. Specifically in accordance with an exemplary embodiment, the segments are configured at least in part as plates of uniform thickness and density and the segments overlap each other to form at least one continuous, materially homogenous transport area of uniform thickness and density to provide at least one continuous gapless band of uniform transmissivity to radiation in the transport area of the conveyor chain, wherein the connector elements are located outside the transport area.

This continuous, materially homogenous transport area of uniform thickness and density is a central aspect of an exemplary embodiment, as it may ensure that the part of the conveyor which supports the articles under inspection has a uniform transmissivity for the scanning radiation. This means that an exemplary embodiment of the conveyor comprises in its transport area a homogenous radiographic cross section, i.e., a cross section with insignificant loss of transmitted electromagnetic radiation intensity at any boundary surfaces when passing the conveyor chain.

In one exemplary embodiment, the connector elements through which the segments of the conveyor chain are articulately joined together are preferably configured as hinges which are arranged in pairs in the outside border areas of the conveyor chain, so that the continuous, materially homogenous transport area is not traversed by the hinges and runs as a continuous band along a median area of the conveyor chain between said outside border areas.

In an exemplary embodiment, the connector elements, in particular the hinges, are preferably arranged on the underside, i.e., the inside surface of the conveyor chain loop, so that the outward-facing surface or transport surface of the conveyor chain loop is flat and unobstructed, which facilitates, for example, the sideways transfer of objects from one conveyor chain to another.

In an exemplary embodiment, the segments of the conveyor chain may be made of a synthetic material that is transmittant to high-energy electromagnetic radiation and at the same time rigid and wear-resistant. Two commonly available materials that meet these requirements are acetal resin and polypropylene, which are named here only as examples without implying any limitations in the choice of a suitable material. The hinge pins may likewise be made of a synthetic material, but since they are located outside the transport area, they may also be made of metal.

As one specific application, it is envisioned that an exemplary embodiment of the conveyor chain may be used advantageously in an X-ray inspection system for food and beverage containers. However, as will be readily understood, exemplary embodiments are not limited in its applicability by any specific spectral range of the electromagnetic radiation or by the nature of the objects being inspected.

In an exemplary embodiment of the conveyor chain, the cross-sectional profile of the segments in a plane that extends perpendicular to the transport surface and in the lengthwise direction of the conveyor chain may be parallelogram-shaped, so that mutually adjoining sides of neighboring segments are slanted at an oblique angle relative to the lengthwise direction of the conveyor chain. At least for radiation directed in a plane that is orthogonal to the lengthwise direction of the conveyor chain, but also at any oblique angle other than the angle of the mutually abutting sides, the segments may therefore present an overlap at the slanted joints with substantially no change in transmissivity when a joint passes through the curtain of radiation.

As an alternative to the foregoing exemplary embodiment where neighboring segments abut each other in a slanted plane, the conveyor chain segments in another embodiment may have mutually adjoining sides with complementary projecting and receding surface profiles, e.g., convex-curved and concave-curved, so that the segments overlap each other through a mutual engagement between the complementary surface profiles providing substantially uniform transmissivity of electromagnetic radiation, irrespective of the direction of incidence.

Advantageously, the curtain of scanning radiation in an exemplary embodiment may extend in a plane that is inclined at an oblique angle to the transport surface and intersect the latter along a line that runs perpendicular to the transport direction. For the obliquely directed radiation, the segments may therefore effectively present an overlap at the joints, so that there is substantially no change in transmissivity when a joint passes through the inclined curtain of radiation.

A radiographic inspection system according to an exemplary embodiment may include the conveyor chain of the foregoing description, wherein the conveyor chain may serve to transport objects under inspection through a curtain of electromagnetic radiation, which in an exemplary embodiment may extend in a plane that intersects the plane of the transport surface of the conveyor chain along a line that runs perpendicular to the transport direction. In an exemplary embodiment, the system may be equipped with at least one radiation emitter that may be installed at a lateral position above the plane of the transport surface of the conveyor and at least one radiation receiver that may be installed at a lateral position below the plane of the transport surface of the conveyor.

One exemplary embodiment of this radiographic inspection system may be equipped with two radiation emitters and two corresponding radiation receivers which may be installed at opposite sides of the conveyor.

In addition to the novel features and advantages mentioned above, other benefits will be readily apparent from the following descriptions of the drawings and exemplary embodiments.

### BRIEF DESCRIPTION OF THE DRAWINGS

FIG. 1 shows a cross-sectional view of an exemplary embodiment of a conveyor chain, with a container traveling on the conveyor and two radiation beams of a radiographic inspection system traversing the container and the conveyor chain.

FIG. 2 shows a side elevation view of the conveyor chain and container of FIG. 1.

FIG. 3 shows a perspective view of the conveyor chain and container of FIGS. 1 and 2.

FIG. 4 represents a side elevation view of the conveyor chain of FIGS. 1 to 3 with a drive sprocket and sweeper brush.

FIGS. 5(a) and 5(b) represent partial side elevation views of further exemplary embodiments of conveyor chains.

FIG. 6 shows perspective views of a further exemplary embodiment of a conveyor chain.

FIG. 7 shows perspective views of another exemplary embodiment of a conveyor chain.

### DETAILED DESCRIPTION OF EXEMPLARY EMBODIMENT(S)

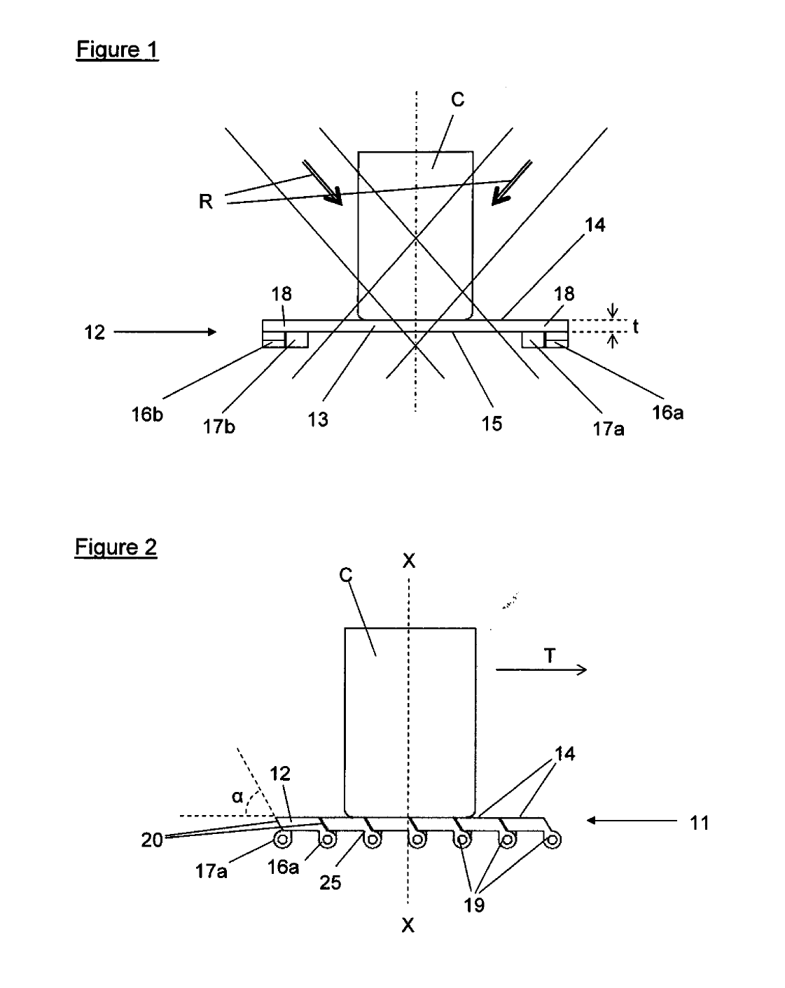

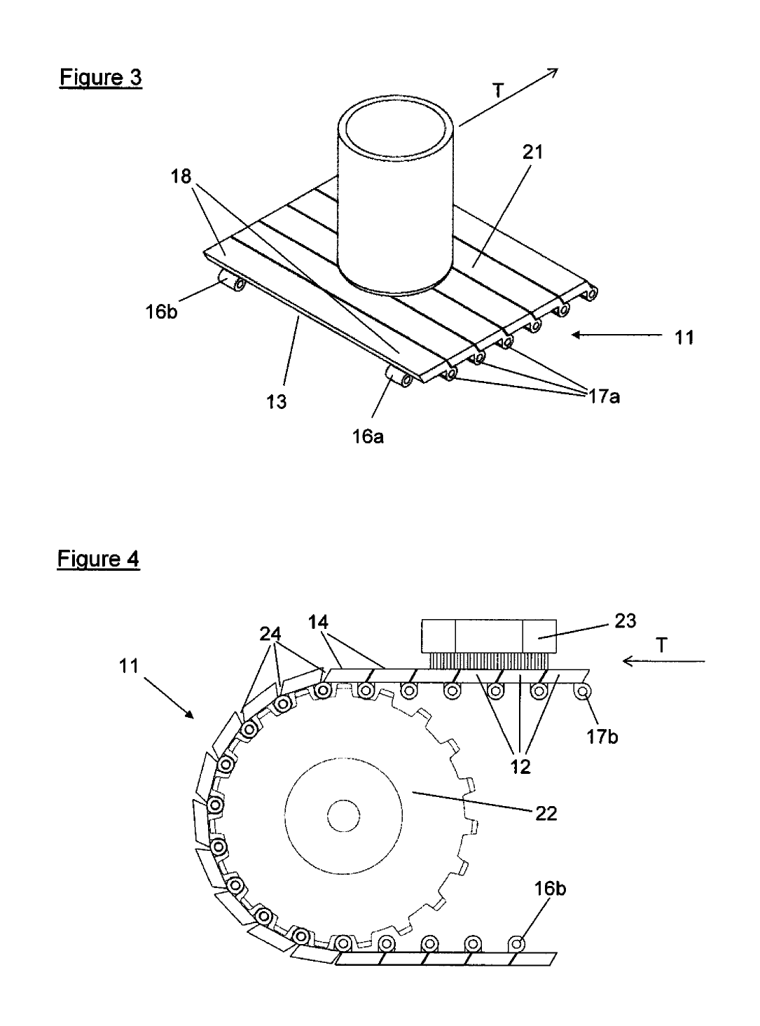

An exemplary embodiment of a conveyor chain 11 is shown in four different views in FIGS. 1 to 4. Viewed in the direction of movement of the conveyor chain, FIG. 1 schematically represents a conveyor chain segment 12 with a container C at the moment when the container C passes through the beams of a scanning radiation R of a radiographic inspection system (wherein the latter is not shown in the drawing). In this exemplary embodiment, the conveyor chain segment 12 has a flat topside 14 forming part of the transport surface 21 (see FIG. 3) of the conveyor chain 11. The mid-section 13 of the conveyor chain segment 12, which is traversed by the scanning radiation R, is of a substantially uniform thickness t. Hinge bearings are arranged on the underside 15 of the conveyor chain segment 12 in the outside border areas 18 that are not traversed by the scanning radiation R. In this embodiment, the part of the underside 15 that covers the mid-section 13 is flat and parallel to the topside 14. Relative to the travel direction T (see FIGS. 2 to 4) of the conveyor belt 11, a first pair of hinge bearings 16a, 16b is arranged at the leading edge and a second pair of hinge bearings 17a, 17b is arranged at the trailing edge of each conveyor chain segment 12.

FIG. 2 shows a section of six segments 12 of the conveyor chain 11, illustrating in particular the arrangement of the hinge bearings 16a, 17a on the right side of the segments 12 (relative to the travel direction T of the conveyor chain) and of the hinge pins 19 connecting the hinge bearings 16a, 17a to each other. Also apparent is the parallelogram-shaped cross-sectional profile of the segments 12 in this exemplary embodiment, with the mutually abutting sides 20 of the segments inclined at an oblique angle α relative to the flat topsides 14 of the segments 12, which form the transport surface. In an exemplary embodiment, this angled position of the mutually abutting sides 20 of the segments, also referred to herein as an overlap between neighboring segments, has the effect that for scanning rays whose paths run in a plane represented for example by the line X-X, i.e., a plane that is perpendicular to the transport direction, the conveyor chain 11 presents a substantially uniform material thickness t even at the joints between the segments 12. It should be noted, however, that the plane of the scanning radiation (also referred to herein as the radiation curtain) does not necessarily have to be perpendicular to the transport direction but may be inclined relative to the transport surface at any oblique angle other than the angle α of the mutually abutting sides 20.

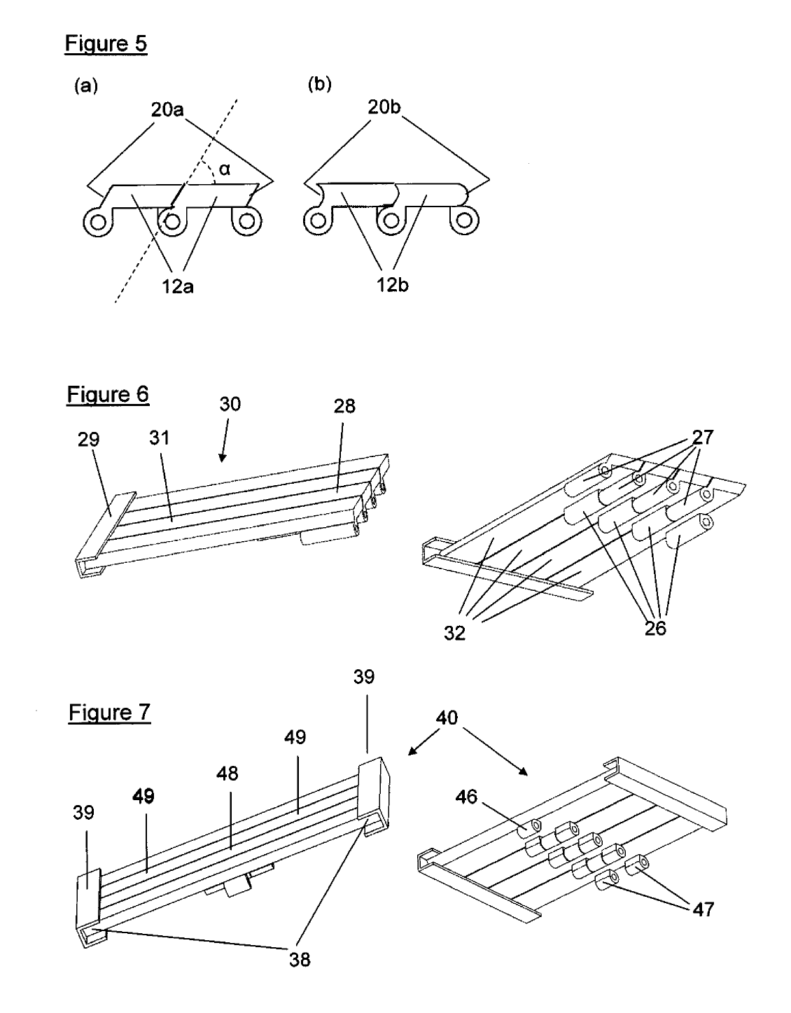

As can be clearly seen from the exemplary embodiment in FIG. 2, the hinge bearings 16a, 17a (as well as hinge bearings 16b, 17b) are formed as an integral part of the segments 12, and are arranged outside the transport area—here the mid-section 13 of the segment as shown in FIG. 1—of the conveyor chain. In this example, the hinge bearings 16a, 16b, 17a, 17b are of cylindrical shape, wherein the outer radius for each cylindrical hinge bearing 16a, 16b, 17a, 17b is directly located at the underside 15 of a segment plate 12 and comprises an inwardly, i.e., towards the center of the segments, directed region of reinforcement 25 (see also FIGS. 5(a), 5(b) and 6).

FIG. 3 represents a perspective view of the same section of the conveyor chain 11 that is shown in the side view of FIG. 2. FIG. 3 illustrates in particular the flat transport surface 21 of the conveyor chain 11 with the materially homogeneous mid-section 13 of substantially uniform thickness and density, which extends as a continuous band between the border areas 18 in which the hinges 16a, 16b, 17a, 17b are arranged.

FIG. 4 illustrates how the conveyor chain 11 according to an exemplary embodiment may be supported and driven by sprockets 22, which engage the hinges 16a, 16b, 17a, 17b. Also shown is a brush 23 which may be installed to sweep, for example, broken glass and debris off the conveyor before the chain moves around the sprocket where the joints 24 open up and then close again, wherein debris may otherwise become caught and compacted in the joints 24. The exemplary embodiment of FIG. 4 further shows with particular clarity how the articulate connection between the segments 12 may allow neighboring segments to flex against each other from a substantially straight line to a convex angle in relation to the chain loop, so that the conveyor chain 11 is able to conform to the sprocket 22 but essentially resists flexing in the opposite direction. As a result, for example, the straight section of the conveyor chain in the area of the brush 23 may behave like a rigid platform which may not sag under the load of objects that are placed on it.

FIGS. 5(a) and 5(b) show examples of different ways in which the requirement of uniform transmissivity across the joint from one segment to the next may be achieved. In the exemplary embodiment (a) where the conveyor chain segments 12a have a parallelogram-shaped profile, it was found that the advantage of substantially uniform transmissivity may be achieved comfortably if the mutually adjoining parallelogram sides 20a are inclined at an angle α of about 60°. However, depending on other parameters of the conveyor chain 11 such as, for example the thickness t, a larger or smaller angle α may prove advantageous. It goes without saying that such variations of the angle α are entirely within the scope of the invention.

As one alternative to the exemplary embodiment of FIG. 5(a) where neighboring segments abut each other in a slanted plane, the conveyor chain segments 12b in the embodiment of FIG. 5(b) have mutually adjoining sides 20b with complementary projecting and receding surface profiles, in this example convex-curved and concave-curved, so that the segments overlap each other through a mutual engagement between the complementary surface profiles.

As the embodiment of FIG. 6 illustrates, the continuous, materially homogeneous area of the conveyor chain according to an exemplary embodiment may also be realized in a conveyor chain 30 where hinge bearings 26, 27 are arranged only along one border area 28 of the conveyor chain. The opposite border may in this example be guided in a guide channel 29 in order to keep the conveyor chain segments 32 in parallel alignment and to ensure that the transport surface 31 stays substantially flat.

As yet a further possibility, the continuous, materially homogeneous area of the conveyor chain according to an exemplary embodiment may also be realized in a conveyor chain 40 as shown in FIG. 7, where hinge bearings 46, 47 are arranged only along a median zone 48 of the conveyor chain 40 and both border areas 38 of the chain are guided in guide channels 39. This example of conveyor chain 40 has two continuous, materially homogeneous areas, i.e., two transport lanes 49 running parallel along either side of the median zone 48.

Although exemplary embodiments have been described through a presentation of specific examples of embodiments, it is considered obvious that numerous further alternative embodiments may be created from a knowledge of the present invention, for example by combining features of the individual examples with each other and/or by interchanging individual features of the exemplary embodiments. For example, the variations of the profile shape of the conveyor chain segments which are illustrated in FIGS. 5(a) and 5(b) may be combined with a non-perpendicular angle of the curtain of radiation R.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A conveyor chain for a radiographic inspection system, comprising:
a plurality of rigid segments which extend substantially over an entire width of the conveyor chain and are configured at least in part as plates of a substantially uniform thickness and a substantially uniform density and which in a lengthwise direction of the conveyor chain are connected together in a closed loop, said segments overlapping each other to form at least one substantially continuous, materially homogenous transport area of substantially uniform thickness and density to provide at least one substantially continuous gapless band of substantially uniform transmissivity to radiation in the transport area of the conveyor chain; and
a plurality of connector elements coupling each segment articulately to a following segment and a preceding segment such that neighboring segments are adapted to flex against each other from a substantially straight line to a convex angle in relation to the closed loop, so that the conveyor chain is adapted to conform to conveyor rollers or sprockets, but is essentially resistant to flexing in an opposite direction;
wherein the connector elements are located outside the transport area.

2. The conveyor chain according to claim 1, wherein the connector elements are hinges.

3. The conveyor chain according to claim 2, wherein:
said hinges are arranged in outside border areas of the segments; and
said at least one substantially continuous, materially homogenous transport area is formed in a median area between said outside border areas.

4. The conveyor chain according to claim 2, wherein:
said hinges are arranged in one outside border area of the segments while an opposite outside border area of the segments is guided in a guide channel; and
said at least one substantially continuous, materially homogenous transport area is formed in a median area between said outside border area and said guide channel.

5. The conveyor chain according to claim 2, wherein:
said hinges are arranged in a median zone of the segments while outside border areas of the segments are guided in guide channels; and
two said substantially continuous, materially homogenous transport areas are formed on either side of said median zone, delimited at the outside border areas (38) by the guide channels.

6. The conveyor chain according to claim 1, wherein the conveyor chain has a top side forming a flat transport surface and further has an underside such that said connector elements are arranged on the underside.

7. The conveyor chain according to claim 1, wherein the segments are comprised of a synthetic material which is transmittant to a high-energy electromagnetic radiation.

8. The conveyor chain according to claim 7, wherein the synthetic material is selected from the group consisting of acetal resin and polypropylene.

9. The conveyor chain according to claim 7, wherein said high-energy electromagnetic radiation is in a spectral range of X-rays.

10. The conveyor chain according to claim 1, wherein the segments are respectively of parallelogram-shaped cross-section relative to a plane that extends perpendicular to a transport surface and in the lengthwise direction of the conveyor chain, such that mutually adjoining sides of the neighboring segments are biased at an oblique angle relative to the lengthwise direction of the conveyor chain and the segments overlap each other in the lengthwise direction of the conveyor chain.

11. The conveyor chain according to claim 1, wherein mutually adjoining sides of the neighboring segments have complementary projecting and receding surface profiles, so that the segments overlap each other through a mutual engagement between said complementary surface profiles.

12. The conveyor chain according to claim 11, wherein the complementary surface profiles are, respectively, convex-curved and concave-curved, so that the segments overlap each other through mutual engagement between said curved profiles.

13. The conveyor chain according to claim 2, wherein:
the hinges are comprised of hinge bearings; and
the hinge bearings are respectively formed as integral parts of the segments and arranged outside the transport area of the conveyor chain.

14. The conveyor chain according to claim 13, wherein:
the hinge bearings are of cylindrical shape; and
an outer radius of each cylindrical hinge bearing is directly located at an underside of a respective segment and comprises an inwardly directed region of reinforcement.

15. A radiographic inspection system comprising:
a conveyor chain comprising a transport surface adapted to transport objects under inspection through a curtain of electromagnetic radiation, said conveyor chain having at least one substantially continuous gapless band of substantially uniform transmissivity to radiation in a transport area;
at least one radiation emitter at a lateral position above a plane of the transport surface of the conveyor chain; and
at least one radiation receiver at a lateral position below the plane of the transport surface of the conveyor chain.

16. The radiographic inspection system according to claim 15, wherein said curtain of electromagnetic radiation extends in a plane that intersects the plane of the transport surface along a line that runs perpendicular to a transport direction.

17. The radiographic inspection system according to claim 15, wherein two said radiation emitters and two said corresponding radiation receivers are at opposite sides of the conveyor chain.

18. The radiographic inspection system according to claim 15, wherein the conveyor chain is comprised of a plurality of rigid segments which extend substantially over an entire width of the conveyor chain such that neighboring segments effectively overlap each other relative to the curtain of electromagnetic radiation that is adapted to extend in a plane that is inclined relative to the transport surface in a direction of transport at an angle different from 90° and is adapted to intersect the transport surface along a line that runs perpendicular to a lengthwise direction of the conveyor chain.

19. The radiographic inspection system according to claim 15, wherein:
said conveyor chain is comprised of a plurality of rigid segments which extend substantially over an entire width of the conveyor chain, said conveyor chain further comprising a plurality of connector elements coupling each segment articulately to a following segment and a preceding segment; and
the connector elements are located outside the transport area.

20. A radiographic inspection system comprising:
a conveyor chain comprising:
a) a plurality of rigid segments which extend substantially over an entire width of the conveyor chain and are configured at least in part as plates of a substantially uniform thickness and a substantially uniform density and which in a lengthwise direction of the conveyor chain are connected together in a closed loop, said segments overlapping each other to form at least one substantially continuous, materially homogenous transport area of substantially uniform thickness and density to provide at least one substantially continuous gapless band of substantially uniform transmissivity to radiation in the transport area of the conveyor chain; and
b) a plurality of connector elements located outside the transport area, said connector elements coupling each segment articulately to a following segment and a preceding segment such that neighboring segments are adapted to flex against each other from a substantially straight line to a convex angle in relation to the closed loop, so that the conveyor chain is adapted to conform to conveyor rollers or sprockets, but is essentially resistant to flexing in an opposite direction;
at least one radiation emitter at a lateral position above a plane of the transport surface of the conveyor chain; and
at least one radiation receiver at a lateral position below the plane of the transport surface of the conveyor chain.
